(19) United States
(12) Patent Application Publication
(10) Pub. No.: US 2025/0056505 A1
(43) Pub. Date: Feb. 13, 2025

(54) DEMODULATION REFERENCE SIGNAL BUNDLING WITH ANTENNA SWITCHING

(71) Applicant: QUALCOMM Incorporated, San Diego, CA (US)

(72) Inventors: Xiao Feng WANG, San Diego, CA (US); Alberto RICO ALVARINO, San Diego, CA (US); Peter GAAL, San Diego, CA (US); Gokul SRIDHARAN, Sunnyvale, CA (US); Chiranjib SAHA, Lakeside, CA (US); Harikumar KRISHNAMURTHY, San Diego, CA (US)

(21) Appl. No.: 18/644,911

(22) Filed: Apr. 24, 2024

Related U.S. Application Data
(60) Provisional application No. 63/518,845, filed on Aug. 10, 2023.

(51) Int. Cl. H04W 72/0446; H04B 7/06; H04L 5/00

(52) U.S. Cl. CPC H04W 72/0446; H04B 7/0602; H04L 5/0051

(57) ABSTRACT

Various aspects of the present disclosure generally relate to wireless communication. In some aspects, a user equipment (UE) may identify a nominal time domain window duration and at least one of a quantity of nominal time domain windows or a quantity of actual time domain windows for demodulation reference signal bundling. The UE may calculate, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration. The UE may calculate an adjusted quantity of nominal time domain windows and may identify a plurality of actual time domain windows. Numerous other aspects are described.

### CROSS-REFERENCE TO RELATED APPLICATION

This Patent application claims priority to U.S. Provisional Patent Application No. 63/518,845, filed on Aug. 10, 2023, entitled “DEMODULATION REFERENCE SIGNAL BUNDLING WITH ANTENNA SWITCHING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for demodulation reference signal bundling with antenna switching.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include identifying a nominal time domain window duration and at least one of a quantity of nominal time domain windows or a quantity of actual time domain windows for demodulation reference signal bundling. The method may include calculating, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration. The method may include calculating an adjusted quantity of nominal time domain windows in accordance with the adjusted nominal time domain window duration. The method may include identifying a plurality of actual time domain windows in accordance with the adjusted quantity of nominal time domain windows. The method may include transmitting, to a network node, using the plurality of actual time domain windows, a communication using demodulation reference signal bundling.

Some aspects described herein relate to a method of wireless communication performed by a UE. The method may include identifying a nominal time domain window duration and a quantity of nominal time domain windows for demodulation reference signal bundling. The method may include calculating, in accordance with an antenna switching event occurring at an antenna switching event location, another antenna switching event location in accordance with the quantity of nominal time domain windows being equal to a single nominal time domain window and in accordance with an indication that antenna switching is enabled. The method may include identifying a plurality of actual time domain windows. The method may include transmitting, to a network node, using the plurality of actual time domain windows and in accordance with the other antenna switching event location, a communication using demodulation reference signal bundling.

Some aspects described herein relate to a method of wireless communication performed by a UE. The method may include identifying an occurrence of an event that causes a change to at least one of a power consistency or a phase continuity. The method may include transmitting, to a network node, in accordance with the occurrence of the event that causes the change to at least one of the power consistency or the phase continuity, a communication using demodulation reference signal bundling.

Some aspects described herein relate to an apparatus for wireless communication at a UE. The apparatus may include one or more memories and one or more processors coupled to the one or more memories. The one or more processors may be configured to identify a nominal time domain window duration and at least one of a quantity of nominal time domain windows or a quantity of actual time domain windows for demodulation reference signal bundling. The one or more processors may be configured to calculate, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration. The one or more processors may be configured to calculate an adjusted quantity of nominal time domain windows in accordance with the adjusted nominal time domain window duration. The one or more processors may be configured to identify a plurality of actual time domain windows in accordance with the adjusted quantity of nominal time domain windows. The one or more processors may be configured to transmit, to a network node, using the plurality of actual time domain windows, a communication using demodulation reference signal bundling.

Some aspects described herein relate to an apparatus for wireless communication at a UE. The apparatus may include one or more memories and one or more processors coupled to the one or more memories. The one or more processors may be configured to identify a nominal time domain window duration and a quantity of nominal time domain windows for demodulation reference signal bundling. The one or more processors may be configured to calculate, in accordance with an antenna switching event occurring at an antenna switching event location, another antenna switching event location in accordance with the quantity of nominal time domain windows being equal to a single nominal time domain window and in accordance with an indication that antenna switching is enabled. The one or more processors may be configured to identify a plurality of actual time domain windows. The one or more processors may be configured to transmit, to a network node, using the plurality of actual time domain windows and in accordance with the other antenna switching event location, a communication using demodulation reference signal bundling.

Some aspects described herein relate to an apparatus for wireless communication at a UE. The apparatus may include one or more memories and one or more processors coupled to the one or more memories. The one or more processors may be configured to identify an occurrence of an event that causes a change to at least one of a power consistency or a phase continuity. The one or more processors may be configured to transmit, to a network node, in accordance with the occurrence of the event that causes the change to at least one of the power consistency or the phase continuity, a communication using demodulation reference signal bundling.

Some aspects described herein relate to a non-transitory computer-readable medium that stores a set of instructions for wireless communication by a UE. The set of instructions, when executed by one or more processors of the UE, may cause the UE to identify a nominal time domain window duration and at least one of a quantity of nominal time domain windows or a quantity of actual time domain windows for demodulation reference signal bundling. The set of instructions, when executed by one or more processors of the UE, may cause the UE to calculate, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration. The set of instructions, when executed by one or more processors of the UE, may cause the UE to calculate an adjusted quantity of nominal time domain windows in accordance with the adjusted nominal time domain window duration. The set of instructions, when executed by one or more processors of the UE, may cause the UE to identify a plurality of actual time domain windows in accordance with the adjusted quantity of nominal time domain windows. The set of instructions, when executed by one or more processors of the UE, may cause the UE to transmit, to a network node, using the plurality of actual time domain windows, a communication using demodulation reference signal bundling.

Some aspects described herein relate to a non-transitory computer-readable medium that stores a set of instructions for wireless communication by a UE. The set of instructions, when executed by one or more processors of the UE, may cause the UE to identify a nominal time domain window duration and a quantity of nominal time domain windows for demodulation reference signal bundling. The set of instructions, when executed by one or more processors of the UE, may cause the UE to calculate, in accordance with an antenna switching event occurring at an antenna switching event location, another antenna switching event location in accordance with the quantity of nominal time domain windows being equal to a single nominal time domain window and in accordance with an indication that antenna switching is enabled. The set of instructions, when executed by one or more processors of the UE, may cause the UE to identify a plurality of actual time domain windows. The set of instructions, when executed by one or more processors of the UE, may cause the UE to transmit, to a network node, using the plurality of actual time domain windows and in accordance with the other antenna switching event location, a communication using demodulation reference signal bundling.

Some aspects described herein relate to a non-transitory computer-readable medium that stores a set of instructions for wireless communication by a UE. The set of instructions, when executed by one or more processors of the UE, may cause the UE to identify an occurrence of an event that causes a change to at least one of a power consistency or a phase continuity. The set of instructions, when executed by one or more processors of the UE, may cause the UE to transmit, to a network node, in accordance with the occurrence of the event that causes the change to at least one of the power consistency or the phase continuity, a communication using demodulation reference signal bundling.

Some aspects described herein relate to an apparatus for wireless communication. The apparatus may include means for identifying a nominal time domain window duration and at least one of a quantity of nominal time domain windows or a quantity of actual time domain windows for demodulation reference signal bundling. The apparatus may include means for calculating, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration. The apparatus may include means for calculating an adjusted quantity of nominal time domain windows in accordance with the adjusted nominal time domain window duration. The apparatus may include means for identifying a plurality of actual time domain windows in accordance with the adjusted quantity of nominal time domain windows. The apparatus may include means for transmitting, to a network node, using the plurality of actual time domain windows, a communication using demodulation reference signal bundling.

Some aspects described herein relate to an apparatus for wireless communication. The apparatus may include means for identifying a nominal time domain window duration and a quantity of nominal time domain windows for demodulation reference signal bundling. The apparatus may include means for calculating, in accordance with an antenna switching event occurring at an antenna switching event location, another antenna switching event location in accordance with the quantity of nominal time domain windows being equal to a single nominal time domain window and in accordance with an indication that antenna switching is enabled. The apparatus may include means for identifying a plurality of actual time domain windows. The apparatus may include means for transmitting, to a network node, using the plurality of actual time domain windows and in accordance with the other antenna switching event location, a communication using demodulation reference signal bundling.

Some aspects described herein relate to an apparatus for wireless communication. The apparatus may include means for identifying an occurrence of an event that causes a change to at least one of a power consistency or a phase continuity. The apparatus may include means for transmitting, to a network node, in accordance with the occurrence of the event that causes the change to at least one of the power consistency or the phase continuity, a communication using demodulation reference signal bundling.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features May include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of demodulation reference signal bundling, in accordance with the present disclosure.

FIG. 5 is a diagram illustrating a first example of demodulation reference signal bundling with antenna switching, in accordance with the present disclosure.

FIG. 6 is a diagram illustrating a second example of demodulation reference signal bundling with antenna switching, in accordance with the present disclosure.

FIG. 7 is a diagram illustrating an example of event detection for demodulation reference signal bundling, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a UE or an apparatus of a UE, in accordance with the present disclosure.

FIG. 11 is a diagram of an example apparatus for wireless communication, in accordance with the present disclosure.

### DETAILED DESCRIPTION

A demodulation reference signal (DMRS) may carry information that is used to estimate a radio channel for demodulation of an associated physical channel. The design and mapping of the DMRS may be specific to the physical channel for which the DMRS is used for estimation. DMRSs may be used for uplink communications (such as communications from the UE to a network node) and/or for downlink communications (such as communications from the network node to the UE). In the example where the DMRS is used for uplink communications, the DMRS may be transmitted by the UE via a physical uplink shared channel (PUSCH) and/or a physical uplink control channel (PUCCH). In some cases, DMRS bundling may be used to improve an accuracy of DMRS reception and channel estimation. For example, DMRS bundling may improve channel estimation performance when a communication is transmitted over multiple slots (for example, due to an amount of data included in the communication) and via the same channel. DMRS bundling may apply to a PUSCH/PUCCH transmission with multi-slot repetitions, and/or may apply to a single transport block (TB) multi-slot PUSCH transmission. This may enable the network node to use the DMRSs from each of the slots that include the communication (or a respective portion of the communication) for performing a channel estimation, which may improve an accuracy of the channel estimation by the network node. In some cases, the UE may perform antenna switching to improve a transmission performance by the UE. For example, a UE that is transmitting via a first antenna may determine that transmitting via a second antenna may improve transmission performance for example, via an increased diversity gain), and the UE may switch from transmitting via the first antenna to transmitting via the second antenna accordingly. In some cases, the UE may perform the antenna switching during a transmission that uses DMRS bundling. This may result in improper channel estimation by the network node due, for example, to changes to the channel conditions resulting from the antenna switch.

Various aspects relate generally to wireless communications. Some aspects more specifically relate to DMRS bundling with antenna switching. A UE may identify a nominal time domain window (TDW) duration and a quantity of nominal TDWs for DMRS bundling. In some aspects, the UE may calculate, in accordance with the quantity of nominal TDWs being a single nominal TDW, and in accordance with an indication that antenna switching is enabled, an adjusted nominal TDW duration in accordance with applying a parameter to the nominal TDW duration, and may calculate an adjusted quantity of nominal TDWs in accordance with the adjusted nominal TDW duration. In some examples, the parameter may be an integer. For example, the parameter may be an integer having a value of two. In some other aspects, the UE may calculate, in accordance with an antenna switching event occurring at an antenna switching event location, another antenna switching event location in accordance with the quantity of nominal TDWs being equal to a single nominal TDW and in accordance with an indication that antenna switching is enabled. The UE may identify a plurality of actual TDWs, for example, in accordance with the adjusted nominal TDW duration or the other antenna switching location, and may transmit, to a network node, using the plurality of actual TDWs, a communication using DMRS bundling. In some aspects, the UE may identify an occurrence of an event that causes a change to at least one of a power consistency or a phase continuity. In some examples, the event may be an antenna switching event. In some other examples, the event may be associated with a restart of a physical uplink shared channel window enabled condition or a physical uplink control channel window enabled condition. The UE may transmit, to the network node, in accordance with the occurrence of the event that causes the change to at least one of the power consistency or the phase continuity, a communication using DMRS bundling.

Particular aspects of the subject matter described in this disclosure can be implemented to realize one or more of the following potential advantages. In some examples, by calculating an adjusted nominal time domain window duration and an adjusted quantity of nominal time domain windows, or by calculating another antenna switching event location, the described techniques can be used to enable DMRS bundling with antenna switching. Additionally, by calculating the adjusted nominal time domain window duration and the adjusted quantity of nominal time domain windows, or by calculating the other antenna switching event location, the described techniques can be used to maintain a power consistency and/or a phase continuity across communications that use DMRS bundling. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

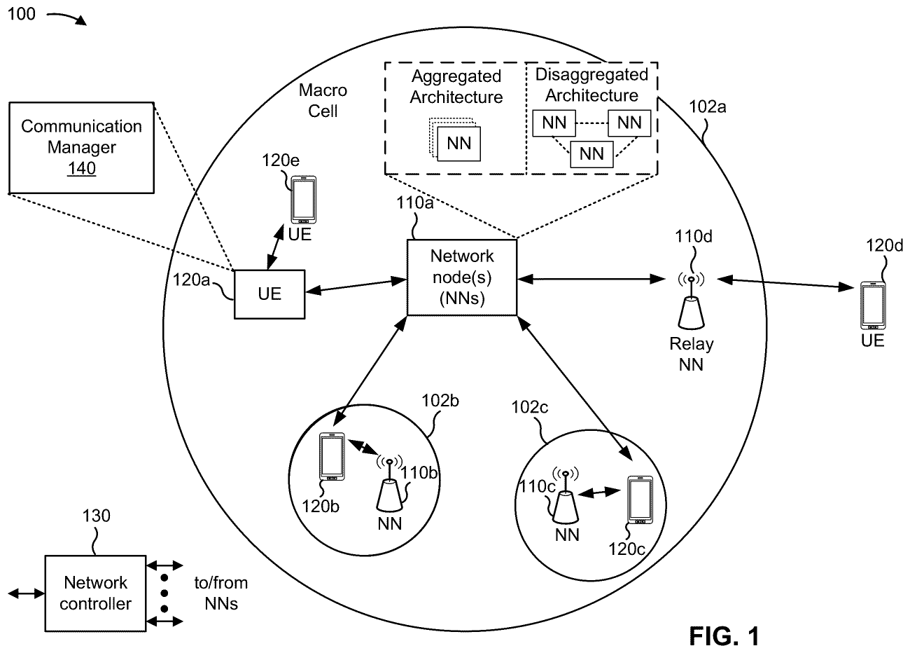

FIG. 1 is a diagram illustrating an example of a wireless network 100, in accordance with the present disclosure. The wireless network 100 may be or May include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. In some aspects, as described in more detail elsewhere herein, the communication manager 140 may identify a nominal time domain window duration and at least one of a quantity of nominal time domain windows or a quantity of actual time domain windows for demodulation reference signal bundling; calculate, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration; calculate an adjusted quantity of nominal time domain windows in accordance with the adjusted nominal time domain window duration; identify a plurality of actual time domain windows in accordance with the adjusted quantity of nominal time domain windows; and transmit, to a network node, using the plurality of actual time domain windows, a communication using demodulation reference signal bundling. In some other aspects, as described in more detail elsewhere herein, the communication manager 140 may identify a nominal time domain window duration and a quantity of nominal time domain windows for demodulation reference signal bundling; calculate, in accordance with an antenna switching event occurring at an antenna switching event location, another antenna switching event location in accordance with the quantity of nominal time domain windows being equal to a single nominal time domain window and in accordance with an indication that antenna switching is enabled; identify a plurality of actual time domain windows in accordance with the antenna switching event causing a change to at least one of a power consistence or a phase continuity; and transmit, to a network node, using the plurality of actual time domain windows and in accordance with the other antenna switching event location, a communication using demodulation reference signal bundling. In some other aspects, as described in more detail elsewhere herein, the communication manager 140 may identify an occurrence of an event that causes a change to at least one of a power consistency or a phase continuity; and transmit, to a network node, in accordance with the occurrence of the event that causes the change to at least one of the power consistency or the phase continuity, a communication using demodulation reference signal bundling. Additionally, or alternatively, the communication manager 140 may perform one or more other operations described herein.

As indicated above, FIG. 1 is provided as an example. Other examples may differ from what is described with regard to FIG. 1.

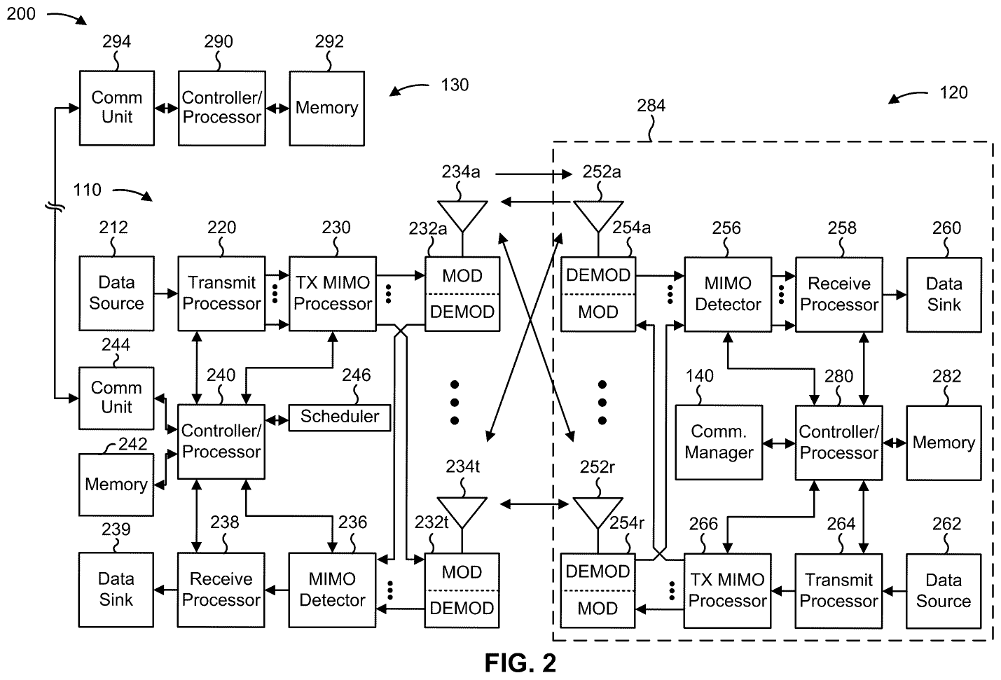

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

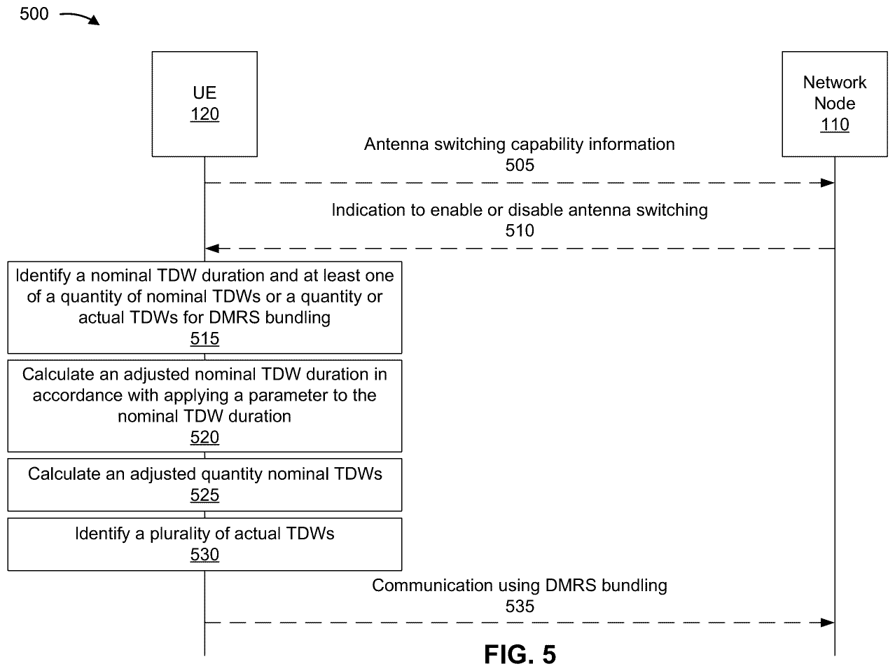

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

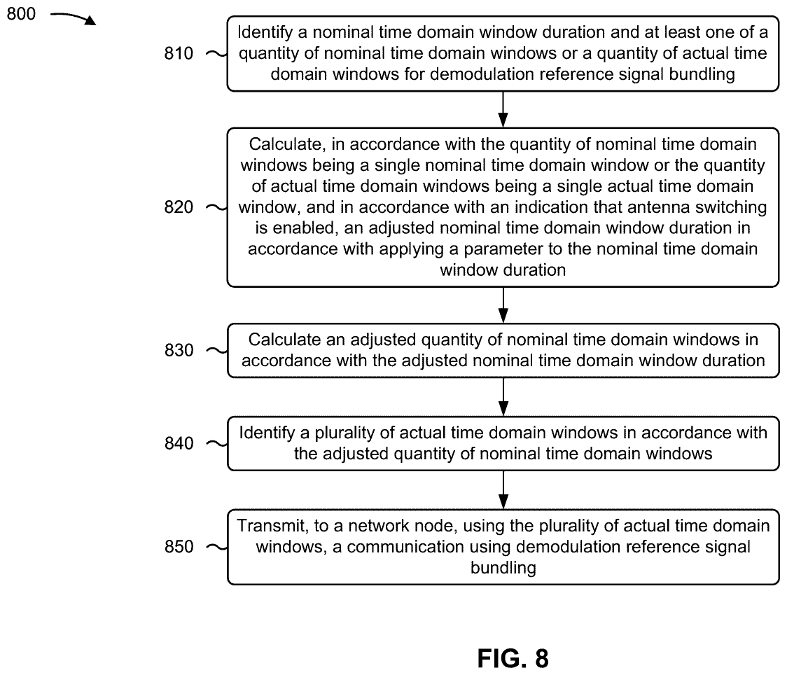

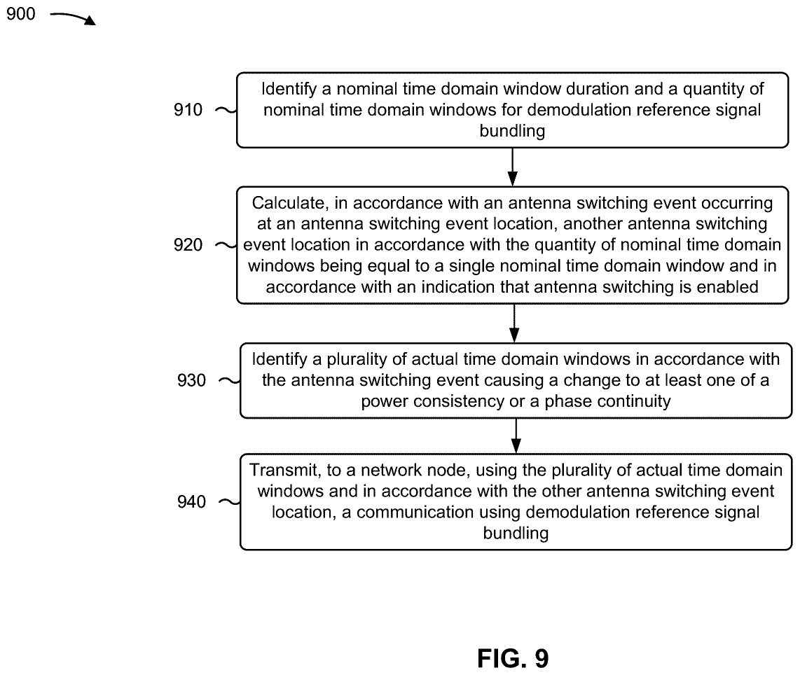

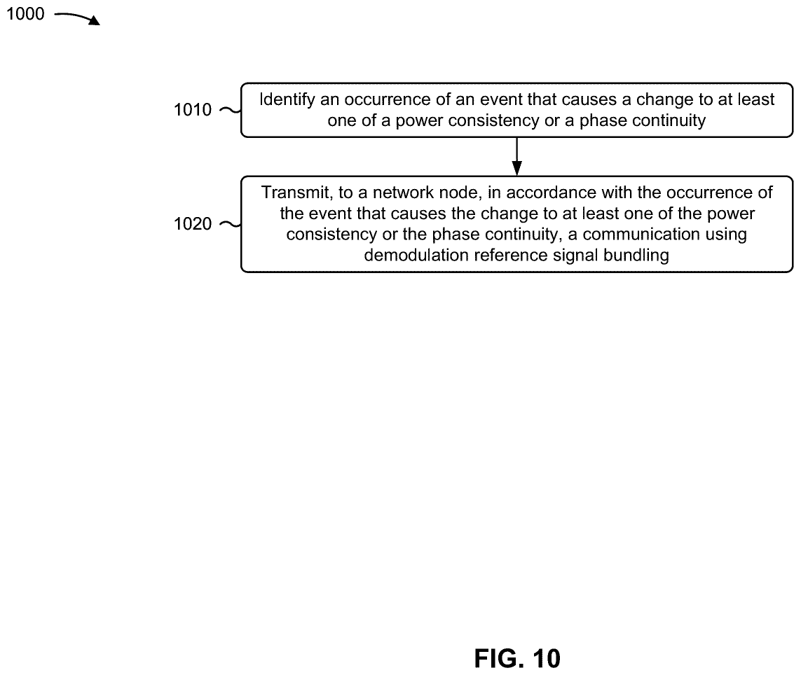

The controller/processor 240 of the network node 110, the controller/processor 280 of the UE 120, and/or any other component(s) of FIG. 2 may perform one or more techniques associated with demodulation reference signal bundling with antenna switching, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for identifying a nominal time domain window duration and at least one of a quantity of nominal time domain windows or a quantity of actual time domain windows for demodulation reference signal bundling; means for calculating, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration; means for calculating an adjusted quantity of nominal time domain windows in accordance with the adjusted nominal time domain window duration; means for identifying a plurality of actual time domain windows in accordance with the adjusted quantity of nominal time domain windows; and/or means for transmitting, to a network node, using the plurality of actual time domain windows, a communication using demodulation reference signal bundling. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for identifying a nominal time domain window duration and a quantity of nominal time domain windows for demodulation reference signal bundling; means for calculating, in accordance with an antenna switching event occurring at an antenna switching event location, another antenna switching event location in accordance with the quantity of nominal time domain windows being equal to a single nominal time domain window and in accordance with an indication that antenna switching is enabled; means for identifying a plurality of actual time domain windows in accordance with the antenna switching event causing a change to at least one of a power consistence or a phase continuity; and/or means for transmitting, to a network node, using the plurality of actual time domain windows and in accordance with the other antenna switching event location, a communication using demodulation reference signal bundling. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for identifying an occurrence of an event that causes a change to at least one of a power consistency or a phase continuity; and/or means for transmitting, to a network node, in accordance with the occurrence of the event that causes the change to at least one of the power consistency or the phase continuity, a communication using demodulation reference signal bundling. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

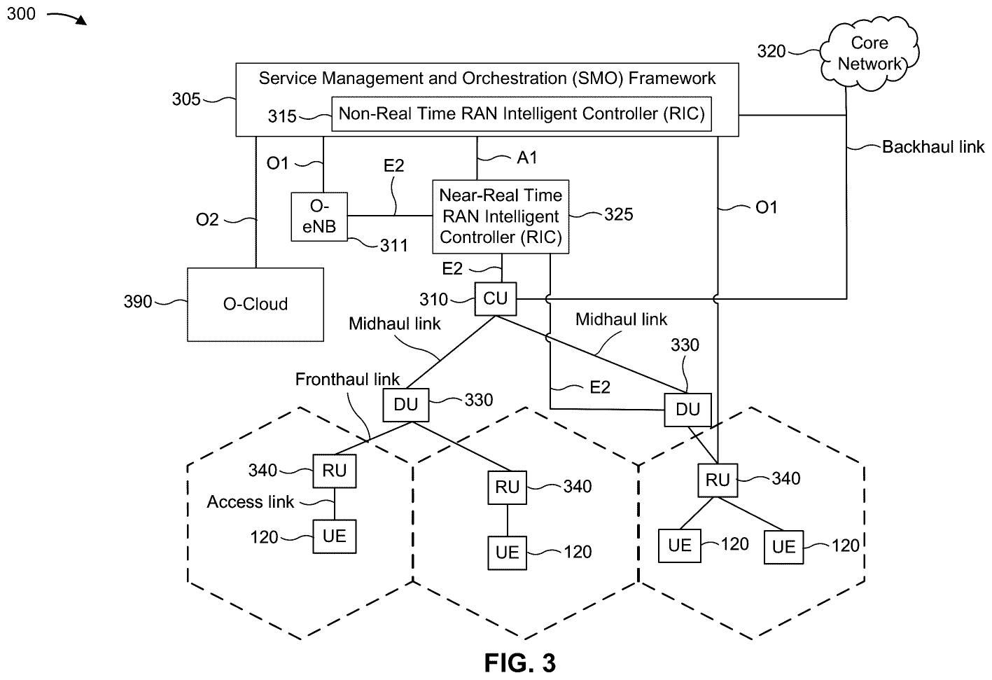

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

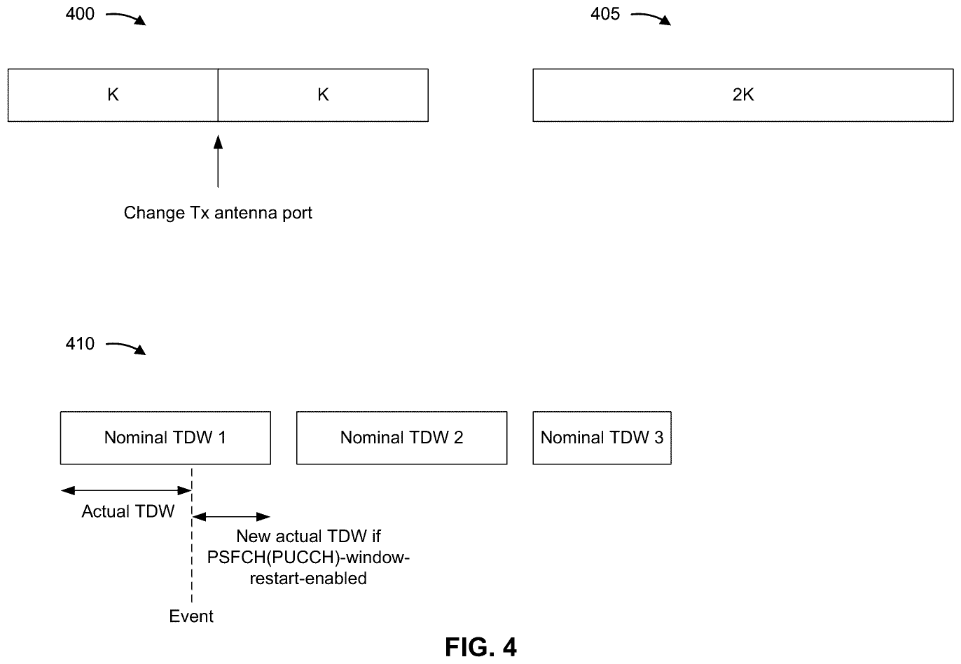

FIG. 4 is a diagram illustrating examples of demodulation reference signal bundling, in accordance with the present disclosure.

DMRS bundling may be used to improve an accuracy of DMRS reception and channel estimation. DMRS bundling may improve channel estimation performance when a communication is transmitted over multiple slots (for example, due to an amount of data included in the communication) and via the same channel. DMRS bundling may apply to a PUSCH/PUCCH transmission with multi-slot repetitions, and/or may apply to a single TB multi-slot PUSCH transmission. This may enable the network node to use the DMRSs from each of the slots that include the communication (or a respective portion of the communication) for performing a channel estimation, which may improve an accuracy of the channel estimation by the network node.

Antenna switching by the UE for uplink communications may provide a performance gain for the uplink communication. A transmission by the UE to a network node (such as a transmission by the UE to a non-terrestrial network (NTN) node) may be a PUSCH transmission with two DMRS bundling windows, where each DMRS bundling window has a duration of K slots. Performing an antenna switch between the first set of K slots and the second set of K slots (as shown in example 400) may provide a performance gain (for example, a 1 decibel (dB) performance gain) compared to a PUSCH transmission that uses a single DMRS bundling window of 2K slots (as shown in example 405).

In some aspects, a UE may determine a time domain window (TDW) for DMRS bundling in accordance with the following. The DMRS bundling may be associated with an uplink transmission by the UE having a duration that is indicated by a quantity of slots. In one example, the transmission by the UE may have a duration of seven slots.

In a first operation, the UE may determine a nominal TDW duration. In one example, as shown in example 410, the UE may determine that the nominal TDW duration is three (e.g., the nominal TDW has a duration of three slots).

In a second operation, the UE may determine the nominal TDWs to be used for the DMRS bundling. In the example where the transmission by the UE has a duration of seven slots, and the nominal TDW duration is three, the UE may determine that a quantity of nominal TDWs is to be three nominal TDWs. As shown in example 410, the UE may determine that the quantity of nominal TDWs is to include nominal TDW 1, nominal TDW 2, and nominal TDW 3. In some aspects, each of the nominal TDWs may have the same duration. In some other aspects, each of the nominal TDWs, except for the last nominal TDW (e.g., nominal TDW 3), may have the same duration. In some aspects, the UE may determine that a first DMRS bundling is to be used for a first nominal TDW (nominal TDW 1), a second DMRS bundling is to be used for the second nominal TDW (nominal TDW 2), and a third DMRS bundling is to be used for the third nominal TDW (nominal TDW 3).

In a third operation, the UE may determine the actual TDWs. The UE may determine the actual TDWs in accordance with the nominal TDW duration and/or the quantity of nominal TDWs. Additionally, the UE may determine the actual TDWs in accordance with an event. The event may correspond to any event that causes power consistency and/or phase continuity not to be maintained across a PUSCH/PUCCH transmission. In one example, the event may correspond to a PUSCH/PUCCH window restart (PUSCH (PUCCH)-window-restart) being enabled. In some aspects, the start of the first actual TDW may be the first symbol of the first PUSCH/PUCCH transmission in a slot determined for the PUSCH/PUCCH transmission within the nominal TDW. In some aspects, the end of the actual TDW may be the last symbol of the last PUSCH transmission in a slot determined for transmission of the PUSCH within the nominal TDW, for example, in accordance with the actual TDW reaching the end of the last PUCCH transmission within the nominal TDW. In some other aspects, the end of the actual TDW may be the last symbol of a PUSCH/PUCCH transmission before the event, in accordance with an event occurrence that causes power consistency and/or phase continuity not to be maintained across PUSCH/PUCCH transmissions of PUSCH/PUCCH repetition within the nominal TDW, and the PUSCH/PUCCH transmission is in a slot determined for transmission of the PUSCH/PUCCH. When a PUSCH (PUCCH)-Window-Restart is enabled, the start of a new actual TDW may be the first symbol of the PUSCH/PUCCH transmission after the event which causes the power consistency and/or phase continuity not to be maintained across the PUSCH/PUCCH transmissions of a PUCCH repetition within the nominal TDW, and the PUCCH transmission may be in a slot determined for transmission of the PUCCH. If an event occurs that causes power consistency and/or phase continuity not to be maintained, the actual TDW may end.

As indicated above, FIG. 4 is provided as an example. Other examples may differ from what is described with regard to FIG. 4.

FIG. 5 is a diagram illustrating an example 500 of demodulation reference signal bundling with antenna switching, in accordance with the present disclosure.

As shown by reference number 505, the UE 120 may transmit, and the network node 110 may receive, antenna switching capability information associated with the UE 120. In some aspects, the network node 110 may transmit an indication that the UE 120 supports antenna switching (e.g., is configured to perform antenna switching and/or is capable of performing antenna switching). In some other aspects, the network node 110 may transmit an indication that the UE 120 does not support antenna switching (e.g., is not configured to perform antenna switching and/or is not capable of performing antenna switching). In some aspects, the antenna switching capability information may include an indication of an antenna switching gap duration. For example, the UE 120 may transmit, and the network node 110 may receive, antenna switching capability information that includes an indication of an antenna switching gap duration.

As shown by reference number 510, the network node 110 may transmit, and the UE 120 may receive, an indication to enable antenna switching or an indication to disable antenna switching. For example, the network node 110 may transmit a transmission antenna switching (TxAntSwitching) configuration parameter that indicates for the UE 120 to enable antenna switching or disable antenna switching. In some aspects, the UE 120 may be configured with a default value that indicates for the UE 120 to enable antenna switching or that indicates for the UE 120 to disable antenna switching. The UE 120 may enable antenna switching or disable antenna switching in accordance with the default value and in accordance with not receiving an indication from the network node 110 associated with enabling antenna switching or disabling antenna switching.

As shown by reference number 515, the UE 120 may identify a nominal TDW duration and a quantity of nominal TDWs for DMRS bundling. In some examples, the UE 120 may identify the nominal TDW duration as described in connection with the first operation of the example 400, and may identify the quantity of nominal TDWs as described in connection with the second operation of example 400.

As shown by reference number 520, the UE 120 may calculate an adjusted nominal TDW duration. The UE 120 may calculate the adjusted nominal TDW duration in accordance with the quantity of nominal TDWs being equal to one. Additionally, or alternatively, the UE 120 may calculate the adjusted nominal TDW duration in accordance with an occurrence of an event, such as an antenna switching event, and/or in accordance with an indication that antenna switching is enabled. In some aspects, the UE 120 may calculate the adjusted nominal TDW duration in accordance with applying a parameter to the nominal TDW duration. In some examples, the parameter may be an integer. For example, the parameter may be an integer having a value of two. In some other aspects, the parameter may not be an integer, or may be an integer having a value that is different than the value of two. In some aspects, calculating the adjusted nominal TDW duration may include rounding the adjusted nominal TDW duration to a next largest integer. For example, the UE 120 may round the adjusted nominal TDW duration to a next largest integer in accordance with the adjusted nominal TDW duration not being equal to an integer. In one example, the nominal TDW duration may be seven, and the parameter may be two. In this case, calculating the adjusted nominal TDW duration may include dividing seven by two to obtain a value of three and a half, and rounding to the next largest integer to obtain a value of four. In another example, the nominal TDW duration may be six, and the parameter may be two. In this case, calculating the adjusted nominal TDW duration may include dividing six by two to obtain a value of three. The UE 120 may not need to round the adjusted TDW duration to a next largest integer in accordance with the adjusted TDW duration being equal to an integer (e.g., three). In some aspects, the UE 120 may calculate the adjusted nominal TDW duration as follows:

If the number of nominal TDW is equal to 1 and TxAntSwitching is enabled, let nominal_TDW_duration=[nominal_TDW_duration/2], where [x] is the immediate integer larger than or equal to x.

As shown by reference number 525, the UE 120 may calculate an adjusted quantity of nominal TDWs. The UE 120 may calculate the adjusted quantity of nominal TDWs in accordance with the adjusted nominal TDW duration. In the example where the nominal TDW duration is equal to seven, the quantity of nominal TDWs is equal to one, and the adjusted nominal TDW duration is equal to four, the UE 120 may calculate an adjusted quantity of nominal TDWs that is equal to two. For example, the UE 120 may determine that the adjusted quantity of nominal TDWs is to be two TDWs, where each TDW of the two TDWs has a duration of four (e.g., four slots). Alternatively, the UE 120 may determine that the adjusted quantity of TDWs is to be two TDWs, where the first TDW of the two TDWs has a duration of four and the second TDW of the two TDWs has a duration of three.

As shown by reference number 530, the UE 120 may identify a plurality of actual TDWs. The UE 120 may identify the plurality of actual TDWs in accordance with at least one of an amount of data to be transmitted, the adjusted nominal TDW duration, or the adjusted quantity of nominal TDWs. In some aspects, the UE 120 may identify the plurality of actual TDWs as described in connection with the third operation of the example 400.

As shown by reference number 535, the UE 120 may transmit, and the network node 110 may receive, a communication using DMRS bundling. For example, the UE 120 may transmit, and the network node 110 may receive, a communication using DMRS bundling and in accordance with the plurality of actual TDWs.

As indicated above, FIG. 5 is provided as an example. Other examples may differ from what is described with regard to FIG. 5.

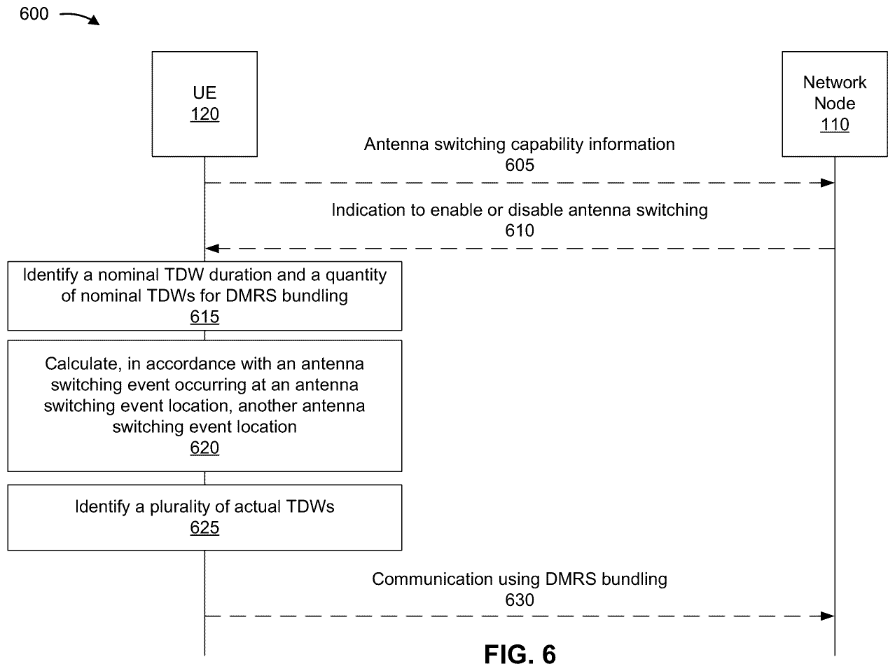

FIG. 6 is a diagram illustrating an example 600 of demodulation reference signal bundling with antenna switching, in accordance with the present disclosure.

As shown by reference number 605, the UE 120 may transmit, and the network node 110 may receive, antenna switching capability information associated with the UE 120. In some aspects, the network node 110 may transmit an indication that the UE 120 supports antenna switching (e.g., is configured to perform antenna switching and/or is capable of performing antenna switching). In some other aspects, the network node 110 may transmit an indication that the UE 120 does not support antenna switching (e.g., is not configured to perform antenna switching and/or is not capable of performing antenna switching). In some aspects, the antenna switching capability information may include an indication of an antenna switching gap duration. For example, the UE 120 may transmit, and the network node 110 may receive, antenna switching capability information that includes an indication of an antenna switching gap duration.

As shown by reference number 610, the network node 110 may transmit, and the UE 120 may receive, an indication to enable antenna switching or an indication to disable antenna switching. For example, the network node 110 may transmit a transmission antenna switching (TxAntSwitching) configuration parameter that indicates for the UE 120 to enable antenna switching or disable antenna switching. In some aspects, the UE 120 may be configured with a default value that indicates for the UE 120 to enable antenna switching or that indicates for the UE 120 to disable antenna switching. The UE 120 may enable antenna switching or disable antenna switching in accordance with the default value and in accordance with not receiving an indication from the network node 110 associated with enabling antenna switching or disabling antenna switching.

As shown by reference number 615, the UE 120 may identify a nominal TDW duration and a quantity of nominal TDWs for DMRS bundling. In some examples, the UE 120 may identify the nominal TDW duration as described in connection with the first operation of the example 400, and may identify the quantity of nominal TDWs as described in connection with the second operation of example 400.

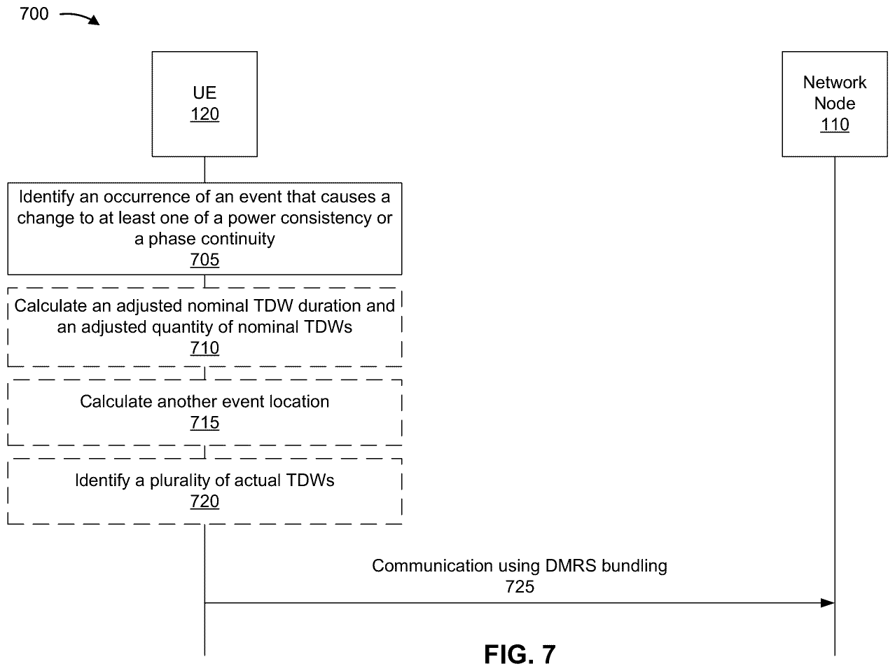

As shown by reference number 620, the UE 120 may calculate another antenna switching event location (e.g., an adjusted antenna switching event location). In some aspects, the UE 120 may identify an occurrence of an event. The event may be an antenna switching event. Alternatively, the event may be any event that causes a change to at least one of a power consistency or a phase continuity. Additional details regarding these features are described in connection with FIG. 7. In some aspects, the antenna switching event may occur at an antenna switching event location. In the example where the nominal TDW duration is seven (e.g., seven slots), the antenna switching event may occur, for example, at the second slot (e.g., at an end of the second slot). The UE 120 may calculate the other antenna switching event location in accordance with detecting the occurrence of the antenna switching event. In some aspects, the UE 120 may calculate the other antenna switching event location in accordance with the quantity of nominal TDWs being equal to a single nominal TDW window. Additionally, or alternatively, the UE 120 may calculate the other antenna switching event location in accordance with an indication that antenna switching is enabled.

In some aspects, calculating the other antenna switching event location may include dividing a quantity of slots associated with a communication to be transmitted by the UE 120 to the network node 110 by a parameter, and setting the other antenna switching event location to a slot location that is equal to the quantity of slots associated with the communication divided by the parameter. In some examples, the parameter may be an integer. For example, the parameter may be an integer having a value of two. In some other aspects, the parameter may not be an integer, or may be an integer having a value that is different than the value of two. In some aspects, calculating the other antenna switching event location may include rounding the other antenna switching event location to a next largest integer. For example, the UE 120 may round the other antenna switching event location duration to a next slot number in accordance with the other antenna switching event location not being equal to an integer. In one example, the communication may span seven slots, and the parameter may be two. In this case, calculating the other antenna switching event location may include dividing seven by two to obtain a value of three and a half, and rounding to the next largest integer to obtain a value of four. Thus, the other antenna switching event location may occur at slot 4 (e.g., at an end of slot 4). In another example, the communication may span six slots, and the parameter may be two. In this case, calculating the other antenna switching event location may include dividing six by two to obtain a value of three. Thus, the other antenna switching event location may occur at slot 3 (e.g., at an end of slot 3). The UE 120 may not need to round the other antenna switching event location to a next largest slot number in accordance with the other antenna switching event location being equal to an integer. In some aspects, the UE 120 may calculate the other antenna switching event location as follows:

If the number of nominal TDW is equal to 1 and TxAntSwitching is enabled, set the Tx antenna event at the at the end of slot x, where x=[N/2] and N is the total transmission duration in slots.

As shown by reference number 625, the UE 120 may identify a plurality of actual TDWs. The UE 120 may identify the plurality of actual TDWs, for example, as described in connection with the third operation of the example 400.

As shown by reference number 630, the UE 120 may transmit, and the network node 110 may receive, the communication. For example, the UE 120 may transmit, and the network node 110 may receive, the communication using DMRS bundling and in accordance with the plurality of actual TDWs.

As indicated above, FIG. 6 is provided as an example. Other examples may differ from what is described with regard to FIG. 6.

FIG. 7 is a diagram illustrating an example 700 of event detection for demodulation reference signal bundling, in accordance with the present disclosure.

As shown by reference number 705, the UE 120 may identify (e.g., detect) an occurrence of an event. The event may be any event that causes a change to at least one of a power consistency or a phase continuity. In some aspects, the event may be an antenna switching event. In some other aspects, the event may be associated with a restart of a physical uplink shared channel window enabled condition or associated with a physical uplink control channel window enabled condition (e.g., that indicates no additional signaling).

As shown by reference number 710, the UE 120 may (optionally) calculate an adjusted nominal TDW duration and an adjusted quantity of nominal TDWs. For example, the UE 120 may calculate the adjusted nominal TDW duration and the adjusted quantity of nominal TDWs as described above in connection with reference numbers 520 and 525 of FIG. 5.

As shown by reference number 715, the UE 120 may (optionally) calculate another event location (e.g., an adjusted event location). For example, the UE 120 may calculate another antenna switching event location (e.g., an adjusted antenna switching event location) as described above in connection with reference number 620 of FIG. 6.

As shown by reference number 720, the UE 120 may (optionally) identify a plurality of actual TDWs. For example, the UE 120 may identify the plurality of actual TDWs as described in connection with the third operation of the example 400.

As shown by reference number 725, the UE 120 may transmit, and the network node 110 may receive, a communication using DMRS bundling. For example, the UE 120 may transmit the communication using DMRS bundling in accordance with identifying the occurrence of the event that causes the change to at least one of the power consistency or the phase continuity.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with demodulation reference signal bundling.

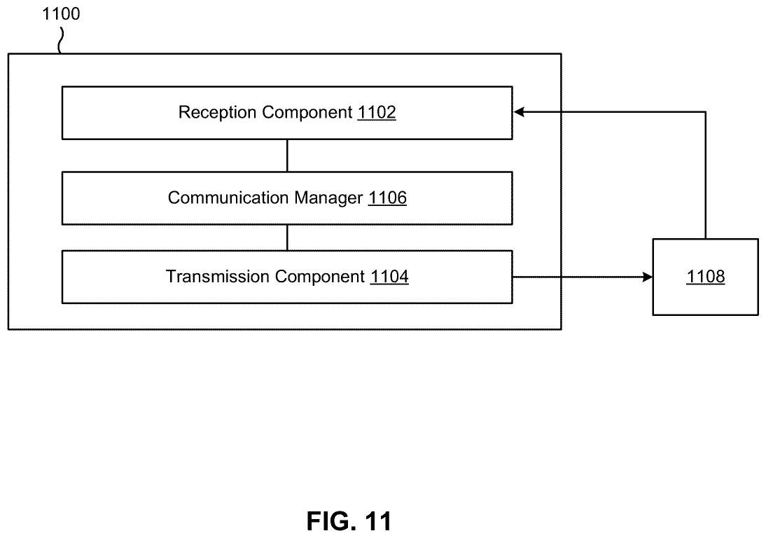

As shown in FIG. 8, in some aspects, process 800 may include identifying a nominal time domain window duration and at least one of a quantity of nominal time domain windows or a quantity of actual time domain windows for demodulation reference signal bundling (block 810). For example, the UE (e.g., using communication manager 1106, depicted in FIG. 11) may a nominal time domain window duration and at least one of a quantity of nominal time domain windows or a quantity of actual time domain windows for demodulation reference signal bundling, as described above.

As further shown in FIG. 8, in some aspects, process 800 may include calculating, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration (block 820). For example, the UE (e.g., using communication manager 1106, depicted in FIG. 11) may calculate, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration, as described above.

As further shown in FIG. 8, in some aspects, process 800 may include calculating an adjusted quantity of nominal time domain windows in accordance with the adjusted nominal time domain window duration (block 830). For example, the UE (e.g., using communication manager 1106, depicted in FIG. 11) may calculate an adjusted quantity of nominal time domain windows in accordance with the adjusted nominal time domain window duration, as described above.

As further shown in FIG. 8, in some aspects, process 800 may include identifying a plurality of actual time domain windows in accordance with the adjusted quantity of nominal time domain windows (block 840). For example, the UE (e.g., using communication manager 1106, depicted in FIG. 11) may identify a plurality of actual time domain windows in accordance with the adjusted quantity of nominal time domain windows, as described above.

As further shown in FIG. 8, in some aspects, process 800 may include transmitting, to a network node, using the plurality of actual time domain windows, a communication using demodulation reference signal bundling (block 850). For example, the UE (e.g., using transmission component 1104 and/or communication manager 1106, depicted in FIG. 11) may transmit, to a network node, using the plurality of actual time domain windows, a communication using demodulation reference signal bundling, as described above.

Process 800 may include additional aspects, such as any single aspect or any combination of aspects described below and/or in connection with one or more other processes described elsewhere herein.

In a first aspect, calculating the adjusted nominal time domain window duration in accordance with applying the parameter to the nominal time domain window duration comprises calculating the adjusted nominal time domain window duration in accordance with dividing the nominal time domain window duration by the parameter.

In a second aspect, alone or in combination with the first aspect, the parameter is an integer.

In a third aspect, alone or in combination with one or more of the first and second aspects, the parameter is equal to two, and the plurality of actual time domain windows is two time domain windows.

In a fourth aspect, alone or in combination with one or more of the first through third aspects, calculating the adjusted nominal time domain window duration further comprises rounding, in accordance with the adjusted nominal time domain window duration not being equal to an integer, the adjusted nominal time domain window duration to a next largest integer.

In a fifth aspect, alone or in combination with one or more of the first through fourth aspects, process 800 includes transmitting, to the network node, an indication that the UE is configured to perform antenna switching.

In a sixth aspect, alone or in combination with one or more of the first through fifth aspects, the indication that the UE is configured to perform antenna switching includes an indication of an antenna switching gap duration.

In a seventh aspect, alone or in combination with one or more of the first through sixth aspects, process 800 includes receiving, from the network node, an indication to enable antenna switching or an indication to disable antenna switching.

In an eighth aspect, alone or in combination with one or more of the first through seventh aspects, the indication to enable antenna switching or the indication to disable antenna switching includes an antenna switching parameter that indicates to enable antenna switching or that indicates to disable antenna switching.

In a ninth aspect, alone or in combination with one or more of the first through eighth aspects, process 800 includes obtaining an indication of a default value that indicates to enable antenna switching or that indicates to disable antenna switching.

In a tenth aspect, alone or in combination with one or more of the first through ninth aspects, process 800 includes enabling the antenna switching or disabling the antenna switching in accordance with the default value and in accordance with identifying that an indication to enable antenna switching or an indication to disable the antenna switching has not been received from the network node.

In an eleventh aspect, alone or in combination with one or more of the first through tenth aspects, the indication that antenna switching is enabled is an indication of an occurrence of an event that causes a change to at least one of a power consistency or a phase continuity.

In a twelfth aspect, alone or in combination with one or more of the first through eleventh aspects, the indication that antenna switching is enabled is an indication of a restart of a physical uplink shared channel window enabled condition or a physical uplink control channel window enabled condition.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with demodulation reference signal bundling.

As shown in FIG. 9, in some aspects, process 900 may include identifying a nominal time domain window duration and a quantity of nominal time domain windows for demodulation reference signal bundling (block 910). For example, the UE (e.g., using communication manager 1106, depicted in FIG. 11) may identify a nominal time domain window duration and a quantity of nominal time domain windows for demodulation reference signal bundling, as described above.

As further shown in FIG. 9, in some aspects, process 900 may include calculating, in accordance with an antenna switching event occurring at an antenna switching event location, another antenna switching event location in accordance with the quantity of nominal time domain windows being equal to a single nominal time domain window and in accordance with an indication that antenna switching is enabled (block 920). For example, the UE (e.g., using communication manager 1106, depicted in FIG. 11) may calculate, in accordance with an antenna switching event occurring at an antenna switching event location, another antenna switching event location in accordance with the quantity of nominal time domain windows being equal to a single nominal time domain window and in accordance with an indication that antenna switching is enabled, as described above.

As further shown in FIG. 9, in some aspects, process 900 may include identifying a plurality of actual time domain windows (block 930). For example, the UE (e.g., using communication manager 1106, depicted in FIG. 11) may identify a plurality of actual time domain windows, as described above.

As further shown in FIG. 9, in some aspects, process 900 may include transmitting, to a network node, using the plurality of actual time domain windows and in accordance with the other antenna switching event location, a communication using demodulation reference signal bundling (block 940). For example, the UE (e.g., using transmission component 1104 and/or communication manager 1106, depicted in FIG. 11) may transmit, to a network node, using the plurality of actual time domain windows and in accordance with the other antenna switching event location, a communication using demodulation reference signal bundling, as described above.

Process 900 may include additional aspects, such as any single aspect or any combination of aspects described below and/or in connection with one or more other processes described elsewhere herein.

In a first aspect, calculating the other antenna switching event location comprises dividing a quantity of slots associated with the communication by a parameter, and setting the other antenna switching event location to a slot location that is equal to the quantity of slots associated with the communication divided by the parameter.

In a second aspect, alone or in combination with the first aspect, the parameter is an integer.

In a third aspect, alone or in combination with one or more of the first and second aspects, the parameter is equal to two.

In a fourth aspect, alone or in combination with one or more of the first through third aspects, process 900 includes identifying that the quantity of slots associated with the communication is not equal to an integer, and rounding the slot location to a slot location that corresponds to a next largest integer, wherein setting the other antenna switching event location to the slot location comprises setting the other antenna switching event location to the slot location that corresponds to the next largest integer.

In a fifth aspect, alone or in combination with one or more of the first through fourth aspects, process 900 includes transmitting, to the network node, an indication that the UE is configured to perform antenna switching.

In a sixth aspect, alone or in combination with one or more of the first through fifth aspects, the indication that the UE is configured to perform antenna switching includes an indication of an antenna switching gap duration.

In a seventh aspect, alone or in combination with one or more of the first through sixth aspects, process 900 includes receiving, from the network node, an indication to enable antenna switching or an indication to disable antenna switching.

In an eighth aspect, alone or in combination with one or more of the first through seventh aspects, the indication to enable antenna switching or the indication to disable antenna switching includes an antenna switching parameter that indicates to enable antenna switching or indicates to disable antenna switching.

In a ninth aspect, alone or in combination with one or more of the first through eighth aspects, process 900 includes obtaining an indication of a default value that indicates to enable antenna switching or indicates to disable antenna switching.

In a tenth aspect, alone or in combination with one or more of the first through ninth aspects, process 900 includes enabling the antenna switching or disabling the antenna switching in accordance with the default value and in accordance with identifying that an indication to enable the antenna switching or an indication to disable the antenna switching has not been received from the network node.

In an eleventh aspect, alone or in combination with one or more of the first through tenth aspects, the indication that antenna switching is enabled is an indication of an occurrence of an event that causes a change to at least one of a power consistency or a phase continuity.

In a twelfth aspect, alone or in combination with one or more of the first through eleventh aspects, the indication that antenna switching is enabled is an indication of a restart of a physical uplink shared channel window enabled condition or a physical uplink control channel window enabled condition.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with demodulation reference signal bundling.

As shown in FIG. 10, in some aspects, process 1000 may include identifying an occurrence of an event that causes a change to at least one of a power consistency or a phase continuity (block 1010). For example, the UE (e.g., using communication manager 1106, depicted in FIG. 11) may identify an occurrence of an event that causes a change to at least one of a power consistency or a phase continuity, as described above.

As further shown in FIG. 10, in some aspects, process 1000 may include transmitting, to a network node, in accordance with the occurrence of the event that causes the change to at least one of the power consistency or the phase continuity, a communication using demodulation reference signal bundling (block 1020). For example, the UE (e.g., using transmission component 1104 and/or communication manager 1106, depicted in FIG. 11) may transmit, to a network node, in accordance with the occurrence of the event that causes the change to at least one of the power consistency or the phase continuity, a communication using demodulation reference signal bundling, as described above.

Process 1000 may include additional aspects, such as any single aspect or any combination of aspects described below and/or in connection with one or more other processes described elsewhere herein.

In a first aspect, the event is an antenna switching event.

In a second aspect, alone or in combination with the first aspect, the event is associated with a restart of a physical uplink shared channel window enabled condition or associated with a physical uplink control channel window enabled condition.

In a third aspect, alone or in combination with one or more of the first and second aspects, process 1000 includes identifying a nominal time domain window duration and a quantity of nominal time domain windows for the demodulation reference signal bundling; calculating, in accordance with the quantity of nominal time domain windows being a single nominal time domain window, an adjusted nominal time domain window duration in accordance with applying a parameter to the nominal time domain window duration; calculating an adjusted quantity of nominal time domain windows in accordance with the adjusted nominal time domain window duration; and identifying a plurality of actual time domain windows in accordance with calculating the adjusted quantity of nominal time domain windows, wherein transmitting the communication using the demodulation reference signal bundling comprises transmitting, to the network node using the plurality of actual time domain windows, the communication using the demodulation reference signal bundling.

In a fourth aspect, alone or in combination with one or more of the first through third aspects, calculating the adjusted nominal time domain window duration in accordance with applying the parameter to the nominal time domain window duration comprises calculating the adjusted nominal time domain window duration in accordance with dividing the nominal time domain window duration by the parameter.

In a fifth aspect, alone or in combination with one or more of the first through fourth aspects, the parameter is an integer.

In a sixth aspect, alone or in combination with one or more of the first through fifth aspects, the parameter is equal to two, and the plurality of actual time domain windows is two time domain windows.

In a seventh aspect, alone or in combination with one or more of the first through sixth aspects, calculating the adjusted nominal time domain window duration further comprises rounding, in accordance with the adjusted nominal time domain window duration not being equal to an integer, the adjusted nominal time domain window duration to a next largest integer.

In an eighth aspect, alone or in combination with one or more of the first through seventh aspects, process 1000 includes identifying a nominal time domain window duration and a quantity of nominal time domain windows for the demodulation reference signal bundling; calculating, in accordance with the event occurring at an event location, an adjusted event location in accordance with the quantity of nominal time domain windows being equal to a single nominal time domain window; and identifying a plurality of actual time domain windows, wherein transmitting the communication using the demodulation reference signal bundling comprises transmitting, to the network node using the plurality of actual time domain windows and in accordance with the adjusted event location, the communication using the demodulation reference signal bundling.

In a ninth aspect, alone or in combination with one or more of the first through eighth aspects, calculating the adjusted event location comprises dividing a quantity of slots associated with the communication by a parameter, and setting the adjusted event location to a slot location that is equal to the quantity of slots associated with the communication divided by the parameter.

In a tenth aspect, alone or in combination with one or more of the first through ninth aspects, the parameter is an integer.

In an eleventh aspect, alone or in combination with one or more of the first through tenth aspects, the parameter is equal to two.

In a twelfth aspect, alone or in combination with one or more of the first through eleventh aspects, process 1000 includes identifying that the quantity of slots associated with the communication is not equal to an integer, and rounding the slot location to a slot location that corresponds to a next largest integer, wherein setting the adjusted event location to the slot location comprises setting the adjusted event location to the slot location that corresponds to the next largest integer.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5-7. Additionally, or alternatively, the apparatus 1100 may be configured to perform one or more processes described herein, such as process 800 of FIG. 8, process 900 of FIG. 9, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may identify a nominal time domain window duration and at least one of a quantity of nominal time domain windows or a quantity of actual time domain windows for demodulation reference signal bundling. The communication manager 1106 may calculate, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration. The communication manager 1106 may calculate an adjusted quantity of nominal time domain windows in accordance with the adjusted nominal time domain window duration. The communication manager 1106 may identify a plurality of actual time domain windows in accordance with the adjusted quantity of nominal time domain windows. The transmission component 1104 may transmit, to a network node, using the plurality of actual time domain windows, a communication using demodulation reference signal bundling.

The transmission component 1104 may transmit, to the network node, an indication that the UE is configured to perform antenna switching. The reception component 1102 may receive, from the network node, an indication to enable antenna switching or an indication to disable antenna switching. The reception component 1102 may obtain an indication of a default value that indicates to enable antenna switching or that indicates to disable antenna switching. The communication manager 1106 may enable the antenna switching or disable the antenna switching in accordance with the default value and in accordance with identifying that an indication to enable antenna switching or an indication to disable the antenna switching has not been received from the network node.

The communication manager 1106 may identify a nominal time domain window duration and a quantity of nominal time domain windows for demodulation reference signal bundling. The communication manager 1106 may calculate, in accordance with an antenna switching event occurring at an antenna switching event location, another antenna switching event location in accordance with the quantity of nominal time domain windows being equal to a single nominal time domain window and in accordance with an indication that antenna switching is enabled. The communication manager 1106 may identify a plurality of actual time domain windows. The transmission component 1104 may transmit, to a network node, using the plurality of actual time domain windows and in accordance with the other antenna switching event location, a communication using demodulation reference signal bundling.

The communication manager 1106 may identify that the quantity of slots associated with the communication is not equal to an integer. The communication manager 1106 may round the slot location to a slot location that corresponds to a next largest integer, wherein setting the other antenna switching event location to the slot location comprises setting the other antenna switching event location to the slot location that corresponds to the next largest integer. The transmission component 1104 may transmit, to the network node, an indication that the UE is configured to perform antenna switching. The reception component 1102 may receive, from the network node, an indication to enable antenna switching or an indication to disable antenna switching. The reception component 1102 may obtain an indication of a default value that indicates to enable antenna switching or indicates to disable antenna switching. The communication manager 1106 may enable the antenna switching or disable the antenna switching in accordance with the default value and in accordance with identifying that an indication to enable the antenna switching or an indication to disable the antenna switching has not been received from the network node.

The communication manager 1106 may identify an occurrence of an event that causes a change to at least one of a power consistency or a phase continuity. The transmission component 1104 may transmit, to a network node, in accordance with the occurrence of the event that causes the change to at least one of the power consistency or the phase continuity, a communication using demodulation reference signal bundling.

The communication manager 1106 may identify a nominal time domain window duration and a quantity of nominal time domain windows for the demodulation reference signal bundling. The communication manager 1106 may calculate, in accordance with the quantity of nominal time domain windows being a single nominal time domain window, an adjusted nominal time domain window duration in accordance with applying a parameter to the nominal time domain window duration. The communication manager 1106 may calculate an adjusted quantity of nominal time domain windows in accordance with the adjusted nominal time domain window duration. The communication manager 1106 may identify a plurality of actual time domain windows in accordance with calculating the adjusted quantity of nominal time domain windows, wherein transmitting the communication using the demodulation reference signal bundling comprises transmitting, to the network node using the plurality of actual time domain windows, the communication using the demodulation reference signal bundling. The communication manager 1106 may identify a nominal time domain window duration and a quantity of nominal time domain windows for the demodulation reference signal bundling. The communication manager 1106 may calculate, in accordance with the event occurring at an event location, an adjusted event location in accordance with the quantity of nominal time domain windows being equal to a single nominal time domain window. The communication manager 1106 may identify a plurality of actual time domain windows, wherein transmitting the communication using the demodulation reference signal bundling comprises transmitting, to the network node using the plurality of actual time domain windows and in accordance with the adjusted event location, the communication using the demodulation reference signal bundling. The communication manager 1106 may identify that the quantity of slots associated with the communication is not equal to an integer. The communication manager 1106 may round the slot location to a slot location that corresponds to a next largest integer, wherein setting the adjusted event location to the slot location comprises setting the adjusted event location to the slot location that corresponds to the next largest integer.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: identifying a nominal time domain window duration and at least one of a quantity of nominal time domain windows or a quantity of actual time domain windows for demodulation reference signal bundling; calculating, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration; calculating an adjusted quantity of nominal time domain windows in accordance with the adjusted nominal time domain window duration; identifying a plurality of actual time domain windows in accordance with the adjusted quantity of nominal time domain windows; and transmitting, to a network node, using the plurality of actual time domain windows, a communication using demodulation reference signal bundling.

Aspect 2: The method of Aspect 1, wherein calculating the adjusted nominal time domain window duration in accordance with applying the parameter to the nominal time domain window duration comprises calculating the adjusted nominal time domain window duration in accordance with dividing the nominal time domain window duration by the parameter.

Aspect 3: The method of Aspect 2, wherein the parameter is an integer.

Aspect 4: The method of Aspect 2, wherein the parameter is equal to two, and the plurality of actual time domain windows is two time domain windows.

Aspect 5: The method of Aspect 2, wherein calculating the adjusted nominal time domain window duration further comprises rounding, in accordance with the adjusted nominal time domain window duration not being equal to an integer, the adjusted nominal time domain window duration to a next largest integer.

Aspect 6: The method of any of Aspects 1-5, further comprising transmitting, to the network node, an indication that the UE is configured to perform antenna switching.

Aspect 7: The method of Aspect 6, wherein the indication that the UE is configured to perform antenna switching includes an indication of an antenna switching gap duration.

Aspect 8: The method of any of Aspects 1-7, further comprising receiving, from the network node, an indication to enable antenna switching or an indication to disable antenna switching.

Aspect 9: The method of Aspect 8, wherein the indication to enable antenna switching or the indication to disable antenna switching includes an antenna switching parameter that indicates to enable antenna switching or that indicates to disable antenna switching.

Aspect 10: The method of any of Aspects 1-9, further comprising obtaining an indication of a default value that indicates to enable antenna switching or that indicates to disable antenna switching.

Aspect 11: The method of Aspect 10, further comprising enabling the antenna switching or disabling the antenna switching in accordance with the default value and in accordance with identifying that an indication to enable antenna switching or an indication to disable the antenna switching has not been received from the network node.

Aspect 12: The method of any of Aspects 1-11, wherein the indication that antenna switching is enabled is an indication of an occurrence of an event that causes a change to at least one of a power consistency or a phase continuity.

Aspect 13: The method of any of Aspects 1-12, wherein the indication that antenna switching is enabled is an indication of a restart of a physical uplink shared channel window enabled condition or a physical uplink control channel window enabled condition.

Aspect 14: A method of wireless communication performed by a user equipment (UE), comprising: identifying a nominal time domain window duration and a quantity of nominal time domain windows for demodulation reference signal bundling; calculating, in accordance with an antenna switching event occurring at an antenna switching event location, another antenna switching event location in accordance with the quantity of nominal time domain windows being equal to a single nominal time domain window and in accordance with an indication that antenna switching is enabled; identifying a plurality of actual time domain windows in accordance with the antenna switching event causing a change to at least one of a power consistence or a phase continuity; and transmitting, to a network node, using the plurality of actual time domain windows and in accordance with the other antenna switching event location, a communication using demodulation reference signal bundling.

Aspect 15: The method of Aspect 14, wherein calculating the other antenna switching event location comprises: dividing a quantity of slots associated with the communication by a parameter; and setting the other antenna switching event location to a slot location that is equal to the quantity of slots associated with the communication divided by the parameter.

Aspect 16: The method of Aspect 15, wherein the parameter is an integer.

Aspect 17: The method of Aspect 15, wherein the parameter is equal to two.

Aspect 18: The method of Aspect 17, further comprising: identifying that the quantity of slots associated with the communication is not equal to an integer; and rounding the slot location to a slot location that corresponds to a next largest integer, wherein setting the other antenna switching event location to the slot location comprises setting the other antenna switching event location to the slot location that corresponds to the next largest integer.

Aspect 19: The method of any of Aspects 14-18, further comprising transmitting, to the network node, an indication that the UE is configured to perform antenna switching.

Aspect 20: The method of Aspect 19, wherein the indication that the UE is configured to perform antenna switching includes an indication of an antenna switching gap duration.

Aspect 21: The method of any of Aspects 14-20, further comprising receiving, from the network node, an indication to enable antenna switching or an indication to disable antenna switching.

Aspect 22: The method of Aspect 21, wherein the indication to enable antenna switching or the indication to disable antenna switching includes an antenna switching parameter that indicates to enable antenna switching or indicates to disable antenna switching.

Aspect 23: The method of any of Aspects 14-22, further comprising obtaining an indication of a default value that indicates to enable antenna switching or indicates to disable antenna switching.

Aspect 24: The method of Aspect 23, further comprising enabling the antenna switching or disabling the antenna switching in accordance with the default value and in accordance with identifying that an indication to enable the antenna switching or an indication to disable the antenna switching has not been received from the network node.

Aspect 25: The method of any of Aspects 14-24, wherein the indication that antenna switching is enabled is an indication of an occurrence of an event that causes a change to at least one of the power consistency or the phase continuity.

Aspect 26: The method of any of Aspects 14-25, wherein the indication that antenna switching is enabled is an indication of a restart of a physical uplink shared channel window enabled condition or a physical uplink control channel window enabled condition.

Aspect 27: A method of wireless communication performed by a user equipment (UE), comprising: identifying an occurrence of an event that causes a change to at least one of a power consistency or a phase continuity; and transmitting, to a network node, in accordance with the occurrence of the event that causes the change to at least one of the power consistency or the phase continuity, a communication using demodulation reference signal bundling.

Aspect 28: The method of Aspect 27, wherein the event is an antenna switching event.

Aspect 29: The method of any of Aspects 27-28, wherein the event is associated with a restart of a physical uplink shared channel window enabled condition or associated with a physical uplink control channel window enabled condition.

Aspect 30: The method of any of Aspects 27-29, further comprising: identifying a nominal time domain window duration and a quantity of nominal time domain windows for the demodulation reference signal bundling; calculating, in accordance with the quantity of nominal time domain windows being a single nominal time domain window, an adjusted nominal time domain window duration in accordance with applying a parameter to the nominal time domain window duration; calculating an adjusted quantity of nominal time domain windows in accordance with the adjusted nominal time domain window duration; and identifying a plurality of actual time domain windows in accordance with calculating the adjusted quantity of nominal time domain windows, wherein transmitting the communication using the demodulation reference signal bundling comprises transmitting, to the network node using the plurality of actual time domain windows, the communication using the demodulation reference signal bundling.

Aspect 31: The method of Aspect 30, wherein calculating the adjusted nominal time domain window duration in accordance with applying the parameter to the nominal time domain window duration comprises calculating the adjusted nominal time domain window duration in accordance with dividing the nominal time domain window duration by the parameter.

Aspect 32: The method of Aspect 31, wherein the parameter is an integer.

Aspect 33: The method of Aspect 31, wherein the parameter is equal to two, and the plurality of actual time domain windows is two time domain windows.

Aspect 34: The method of Aspect 31, wherein calculating the adjusted nominal time domain window duration further comprises rounding, in accordance with the adjusted nominal time domain window duration not being equal to an integer, the adjusted nominal time domain window duration to a next largest integer.

Aspect 35: The method of any of Aspects 27-34, further comprising: identifying a nominal time domain window duration and a quantity of nominal time domain windows for the demodulation reference signal bundling; calculating, in accordance with the event occurring at an event location, an adjusted event location in accordance with the quantity of nominal time domain windows being equal to a single nominal time domain window; and identifying a plurality of actual time domain windows, wherein transmitting the communication using the demodulation reference signal bundling comprises transmitting, to the network node using the plurality of actual time domain windows and in accordance with the adjusted event location, the communication using the demodulation reference signal bundling.

Aspect 36: The method of Aspect 35, wherein calculating the adjusted event location comprises: dividing a quantity of slots associated with the communication by a parameter; and setting the adjusted event location to a slot location that is equal to the quantity of slots associated with the communication divided by the parameter.

Aspect 37: The method of Aspect 36, wherein the parameter is an integer.

Aspect 38: The method of Aspect 36, wherein the parameter is equal to two.

Aspect 39: The method of Aspect 38, further comprising: identifying that the quantity of slots associated with the communication is not equal to an integer; and rounding the slot location to a slot location that corresponds to a next largest integer, wherein setting the adjusted event location to the slot location comprises setting the adjusted event location to the slot location that corresponds to the next largest integer.

Aspect 40: The method of any of Aspects 1-13, further comprising: enabling antenna switching or disabling antenna switching in accordance with a default value that indicates to enable antenna switching or that indicates to disable antenna switching and in accordance with identifying that an indication to enable antenna switching or an indication to disable the antenna switching has not been received from the network node.

Aspect 41: The method of any of Aspects 14-26, further comprising: enabling antenna switching or disabling antenna switching in accordance with a default value that indicates to enable antenna switching or that indicates to disable antenna switching and in accordance with identifying that an indication to enable antenna switching or an indication to disable the antenna switching has not been received from the network node.

Aspect 42: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-41.

Aspect 43: An apparatus for wireless communication at a device, the apparatus comprising one or more memories and one or more processors coupled to the one or more memories, the one or more processors configured to cause the device to perform the method of one or more of Aspects 1-41.

Aspect 44: An apparatus for wireless communication, the apparatus comprising at least one means for performing the method of one or more of Aspects 1-41.

Aspect 45: A non-transitory computer-readable medium storing code for wireless communication, the code comprising instructions executable by one or more processors to perform the method of one or more of Aspects 1-41.

Aspect 46: A non-transitory computer-readable medium storing a set of instructions for wireless communication, the set of instructions comprising one or more instructions that, when executed by one or more processors of a device, cause the device to perform the method of one or more of Aspects 1-41.

Aspect 47: A device for wireless communication, the device comprising a processing system that includes one or more processors and one or more memories coupled with the one or more processors, the processing system configured to cause the device to perform the method of one or more of Aspects 1-41.

Aspect 48: An apparatus for wireless communication at a device, the apparatus comprising one or more memories and one or more processors coupled to the one or more memories, the one or more processors individually or collectively configured to cause the device to perform the method of one or more of Aspects 1-41.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to cause the UE to:
identify a nominal time domain window duration and at least one of a quantity of nominal time domain windows or a quantity of actual time domain windows for demodulation reference signal bundling;
calculate, in accordance with the quantity of nominal time domain windows being a single nominal time domain window or the quantity of actual time domain windows being a single actual time domain window, and in accordance with an indication that antenna switching is enabled, an adjusted nominal time domain window duration in accordance with applying a parameter to the nominal time domain window duration;
calculate an adjusted quantity of nominal time domain windows in accordance with the adjusted nominal time domain window duration;
identify a plurality of actual time domain windows in accordance with the adjusted quantity of nominal time domain windows; and
transmit, to a network node, using the plurality of actual time domain windows, a communication using demodulation reference signal bundling.

2. The UE of claim 1, wherein the one or more processors, to cause the UE to calculate the adjusted nominal time domain window duration in accordance with applying the parameter to the nominal time domain window duration, are configured to cause the UE to calculate the adjusted nominal time domain window duration in accordance with dividing the nominal time domain window duration by the parameter.

3. The UE of claim 2, wherein the parameter is equal to two, and the plurality of actual time domain windows is two time domain windows.

4. The UE of claim 2, wherein the one or more processors, to cause the UE to calculate the adjusted nominal time domain window duration, are configured to cause the UE to round, in accordance with the adjusted nominal time domain window duration not being equal to an integer, the adjusted nominal time domain window duration to a next largest integer.

5. The UE of claim 1, wherein the one or more processors are further configured to cause the UE to transmit, to the network node, an indication that the UE is configured to perform antenna switching.

6. The UE of claim 5, wherein the indication that the UE is configured to perform antenna switching includes an indication of an antenna switching gap duration.

7. The UE of claim 1, wherein the one or more processors are further configured to cause the UE to receive, from the network node, an indication to enable antenna switching or an indication to disable antenna switching.

8. The UE of claim 1, wherein the one or more processors are further configured to cause the UE to enable antenna switching or disable antenna switching in accordance with a default value that indicates to enable antenna switching or that indicates to disable antenna switching and in accordance with identifying that an indication to enable antenna switching or an indication to disable the antenna switching has not been received from the network node.

9. The UE of claim 1, wherein the one or more processors are further configured to cause the UE to obtain a network configuration associated with a nominal time domain window duration that indicates to disable antenna switching.

10. A user equipment (UE) for wireless communication, comprising:
one or more memories; and
one or more processors, coupled to the one or more memories, configured to cause the UE to:
identify a nominal time domain window duration and a quantity of nominal time domain windows for demodulation reference signal bundling;
calculate, in accordance with an antenna switching event occurring at an antenna switching event location, another antenna switching event location in accordance with the quantity of nominal time domain windows being equal to a single nominal time domain window and in accordance with an indication that antenna switching is enabled;
identify a plurality of actual time domain windows in accordance with the antenna switching event causing a change to at least one of a power consistence or a phase continuity; and
transmit, to a network node, using the plurality of actual time domain windows and in accordance with the other antenna switching event location, a communication using demodulation reference signal bundling.

11. The UE of claim 10, wherein the one or more processors, to cause the UE to calculate the other antenna switching event location, are configured to cause the UE to:
divide a quantity of slots associated with the communication by a parameter; and
set the other antenna switching event location to a slot location that is equal to the quantity of slots associated with the communication divided by the parameter.

12. The UE of claim 11, wherein the parameter is equal to two.

13. The UE of claim 12, wherein the one or more processors are further configured to cause the UE to:
identify that the quantity of slots associated with the communication is not equal to an integer; and
round the slot location to a slot location that corresponds to a next largest integer, wherein the one or more processors, to set the other antenna switching event location to the slot location, are configured to set the other antenna switching event location to the slot location that corresponds to the next largest integer.

14. The UE of claim 10, wherein the one or more processors are further configured to cause the UE to transmit, to the network node, an indication that the UE is configured to perform antenna switching.

15. The UE of claim 14, wherein the indication that the UE is configured to perform antenna switching includes an indication of an antenna switching gap duration.

16. The UE of claim 10, wherein the one or more processors are further configured to cause the UE to receive, from the network node, an indication to enable antenna switching or an indication to disable antenna switching.

17. The UE of claim 10, wherein the one or more processors are further configured to cause the UE to enable antenna switching or disable antenna switching in accordance with a default value that indicates to enable antenna switching or that indicates to disable antenna switching and in accordance with identifying that an indication to enable the antenna switching or an indication to disable the antenna switching has not been received from the network node.

18. A user equipment (UE) for wireless communication, comprising:
one or more memories; and
one or more processors, coupled to the one or more memories, configured to cause the UE to:
identify an occurrence of an event that causes a change to at least one of a power consistency or a phase continuity; and
transmit, to a network node, in accordance with the occurrence of the event that causes the change to at least one of the power consistency or the phase continuity, a communication using demodulation reference signal bundling.

19. The UE of claim 18, wherein the event is an antenna switching event.

20. The UE of claim 18, wherein the event is associated with a restart of a physical uplink shared channel window enabled condition or associated with a physical uplink control channel window enabled condition.
